(19) United States
(12) Patent Application Publication
(10) Pub. No.: US 2026/0241407 A1
(43) Pub. Date: Aug. 20, 2026

(54) SHOWER SPRAYER WITH FILTER

(71) Applicant: David K. Farley, Corona, CA (US)

(72) Inventor: David K. Farley, Corona, CA (US)

(21) Appl. No.: 19/057,726

(22) Filed: Feb. 19, 2025

(51) Int. Cl. B05B 15/40; B01D 29/11; B01D 35/04; B01D 35/30; B05B 1/18; C02F 1/00

(52) U.S. Cl. CPC B05B 15/40; B01D 29/11; B01D 35/04; B01D 35/30; B05B 1/18; C02F 1/003; B01D 2201/304; B01D 2201/347; B01D 2201/4092; C02F 2201/004; C02F 2307/06

(57) ABSTRACT

A shower filter for use with a shower sprayer and a water line includes a filter housing configured to be connectable to the water line and the shower sprayer. The filter housing defines an internal void and includes a first housing body and a second housing body detachably engageable to the first housing body at respective peripheral portions of the first and second housing bodies. A filter cartridge is disposable within the internal void of the filter housing and is configured to remove impurities from water flowing through the filter cartridge. A pair of seals are engageable with respective portions of the filter cartridge and the filter housing such that the filter housing, the filter cartridge, and the seals create a fluid pathway through the internal void that is spaced inwardly from the respective peripheral portions of the first and second housing bodies.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a shower filter, and more specifically, to a shower filter having a multi-piece filter housing, and a seals that are spaced inwardly from the engagement of the housing components so as not to interfere with attachment/detachment of the housing components.

### 2. Description of the Related Art

A feature commonly used in combination with a shower sprayer is a water filter to remove impurities from the water prior to the water being dispensed by the shower sprayer. In some cases, the filter may be integrated directly into the shower sprayer, while in other cases, the filter may be separate from the sprayer and positioned upstream of the sprayer.

The filter may include a filter cartridge located within a filter housing. Typically, O-rings are placed at each end of the filter cartridge, with the O-rings being designed to reside between the cartridge and the filter housing. To create a water tight seal, the O-rings may be compressed by screwing the housing halves together.

Most filter cartridges have a limited lifespan, and thus, require replacement after a certain period of time. Thus, to access the filter cartridge, the filter housing is typically opened by unscrewing the two halves of the housing. With the O-rings compressed between the halves of the housing, more force may be required to unscrew the housing components than was originally required to close and seal the unit. In particular, additional force may be needed to overcome the compression surface friction resistance between the compressed O-ring, the filter cartridge and the inner housing wall at both ends. The combined resistance due to O-ring compression and the surface area resistance between the O-ring, filter cartridge and the inner housing wall may be so strong that the force required to open the filter is often more than an average person's strength, making it very difficult or impossible to open. This problem may be amplified over time, as the O-rings may be well lubricated when the unit is assembled; however, the O-ring lubricant may dissipate over time due to heat, O-ring absorption and water flow, drying out the O-ring joint or cell. The O-ring and housing seat may bind together, making it very difficult to open. Monetary costs occur due to returns, canceled sales, customer complaints and service issues and loss of customer good will, among other things.

Accordingly, there is a need in the art for a shower filter having seals for a filter cartridge that do not interfere with detachable engagement of a multi-piece filter housing. Clearance between the seals and the portions of the filter housing components that effectuate engagement between the housing components may make it easier to open the filter housing to access the filter cartridge. Various aspects of the present disclosure address this particular need, as will be discussed in more detail below.

### BRIEF SUMMARY

In accordance with one embodiment of the present disclosure, there is provided a shower filter for use with a shower sprayer and a water line. The shower filter includes a first housing body having a first threaded engagement portion, a first abutment portion, and a water line inlet fluidly connectable to the water line to receive water therefrom. The shower filter additionally includes a second housing body having a second threaded engagement portion, a second abutment portion, and a sprayer outer fluidly connectable to the shower sprayer to dispense water thereto. The second threaded engagement portion is configured to be engageable with the first threaded engagement portion to facilitate abutment of the first abutment portion to the second abutment portion such that first housing body is connected to the second housing body to collectively define an internal housing void. A filter cartridge is positionable within the internal housing void and includes a first surface and a second surface opposite the first surface. The shower filter further includes a pair of seals, with each seal being engageable with a respective one of the first and second surfaces of the filter when the first and second housing bodies are connected to each other. The pair of seals are configured to be spaced from the first and second threaded engagement portions.

The first housing body may be configured to engage with a first one of the pair of seals at a location spaced from the first threaded engagement portion and the second housing body may be configured to engage with a second one of the pair of seals at a location spaced from the second threaded engagement portion.

Each of the pair of seals may be of a diameter that is less than that of the first and second threaded engagement portions. The internal housing void may define a central axis, and each of the pair of seals may be located inward of the first and second threaded engagement portions and toward central axis.

The first housing body, the second housing body, the filter and the pair of seals may be collectively configured such that the pair of seals are compressed between the filter and respective ones of the first and second housing bodies in response to engagement between the first and second housing bodies.

The pair of seals may be configured to fluidly isolate at least a portion of an inner surface of the first housing body and the second housing body from a water flow path through the shower filter.

The filter cartridge may include a first lip configured to extend around a first one of the pair of seals, and a second lip spaced from the first lip and configured to extend around a second one of the pair of seals.

According to another embodiment, there is provided a shower filter for use with a shower sprayer and a water line. The shower filter includes a filter housing configured to be connectable to the water line and the shower sprayer. The filter housing defines an internal void and includes a first housing body and a second housing body detachably engageable to the first housing body at respective peripheral portions of the first and second housing bodies. A filter cartridge is disposable within the internal void of the filter housing and is configured to remove impurities from water flowing through the filter cartridge. A pair of seals are engageable with respective portions of the filter cartridge and the filter housing such that the filter housing, the filter cartridge, and the seals create a fluid pathway through the internal void that is spaced inwardly from the respective peripheral portions of the first and second housing bodies.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a lower perspective view of a shower filter installed on a water line upstream of a shower sprayer;

FIG. 1A is a lower perspective view of the shower filter of FIG. 1 disconnected from the water line and the shower sprayer;

FIG. 2 is a lower perspective exploded view of the shower filter depicting inward placement of a pair of seals that interface with an internal filter cartridge;

FIG. 3 is an upper perspective exploded view of the shower filter; and

FIG. 4 is a cross sectional view of the shower filter.

Common reference numerals are used throughout the drawings and the detailed description to indicate the same elements.

### DETAILED DESCRIPTION

The detailed description set forth below in connection with the appended drawings is intended as a description of certain embodiments of a water filter for a shower sprayer and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating preferred embodiment of the present disclosure, and are not for purposes of limiting the same, there is depicted a shower filter 10 specifically configured and adapted to be installed as an inline filter for use with a shower sprayer 12. The shower filter 10 includes a filter cartridge 14 captured within a multi-part housing assembly capable of being disassembled to enable access to the filter cartridge 14. The filter 10 may additionally include one or more seals 16 to create a water tight engagement between the filter cartridge 14 and the housing assembly. The seals 16 may advantageously be spaced inwardly from the interface between the components of the multi-part housing assembly. The inward position of the seals 16 within the housing, along with having a reduced diameter, may enable a reduction in friction between the housing assembly and the seals 16, while increasing leverage in overcoming any friction between the seals 16 and the housing assembly. Thus, less force may be required to disassemble the housing assembly, thereby making the shower filter 10 more user friendly without compromising functional integrity of the filter 10.

Although conventional shower filters may also include filter cartridges and corresponding seals, it is common that the seals make disassembling of the housing assembly very difficult due to location of the seals typically being at the interface of the housing elements. In this regard, the seals are typically of a diameter that is similar to the threaded engagement portions of the housing. The engagement of the housing components usually imparts a compressed friction force between the seals and the valve housing. The shower filter 10 of the present disclosure aims to avoid that undesirable situation by placing the seals 16 in space relation to the portions of the housing assembly that engage with each other. For instance, the housing assembly may engage via corresponding, threaded cylindrical walls, while the seals 16 may be placed inward of a cylindrical walls. Therefore, the mechanical interaction between the engagement portions is separate from the mechanical interaction or physical interaction between the structures which facilitate the water-tight seal. Furthermore, at least one of the seals may have a particularly reduced diameter, which may reduce the binding surface area friction between the housing and the seal, while also effectively increasing the leverage of the user twisting apart the housing, relative to the smaller seal, which in turn reduces the force required to unscrew the filter housing halves. Thus, the user may more easily disengage the valve housing assembly to access the filter cartridge 14, as may be needed during routine maintenance thereof.

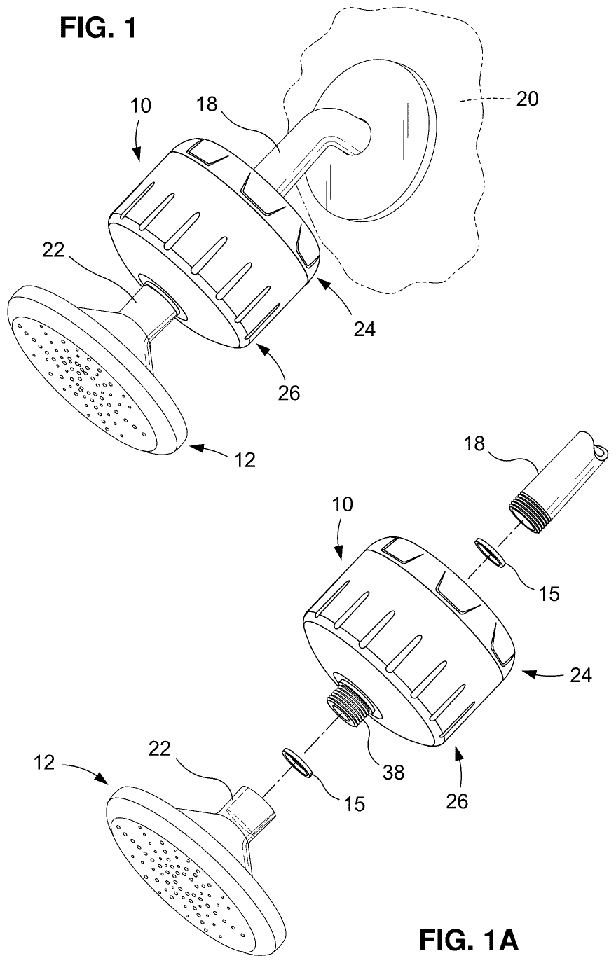

Referring now, specifically to FIG. 1, an embodiment of the shower filter 10 is installed on a water supply line 18, which may extend out from a shower wall 20 to supply water to the shower sprayer 12. The water may be supplied via a municipal water line, or other residential or commercial water supplies known in the art. The water supply line 18 may have a distal end portion that is externally threaded to facilitate engagement with the shower filter 10.

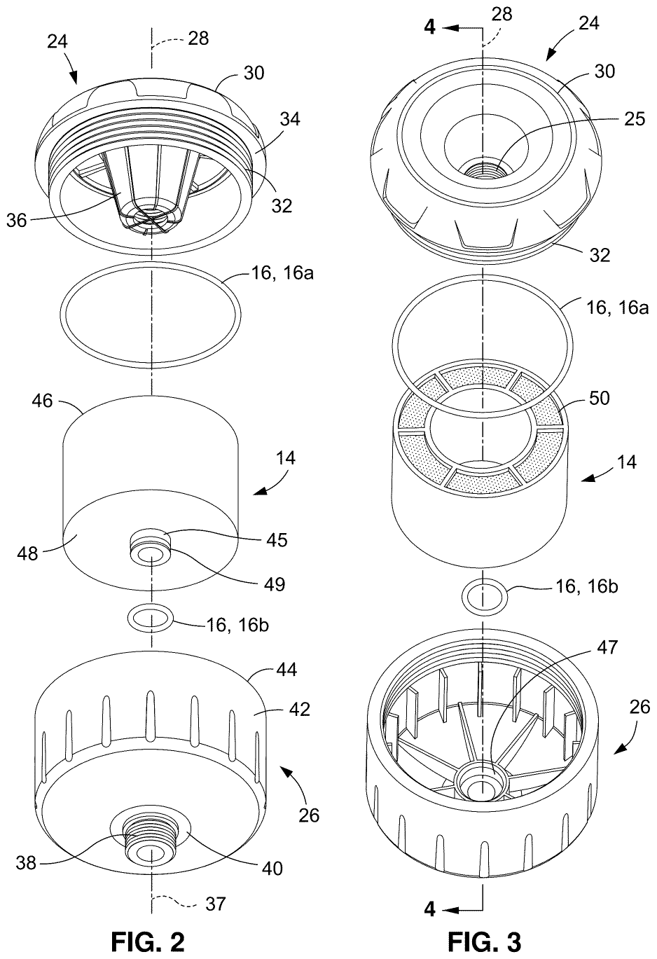

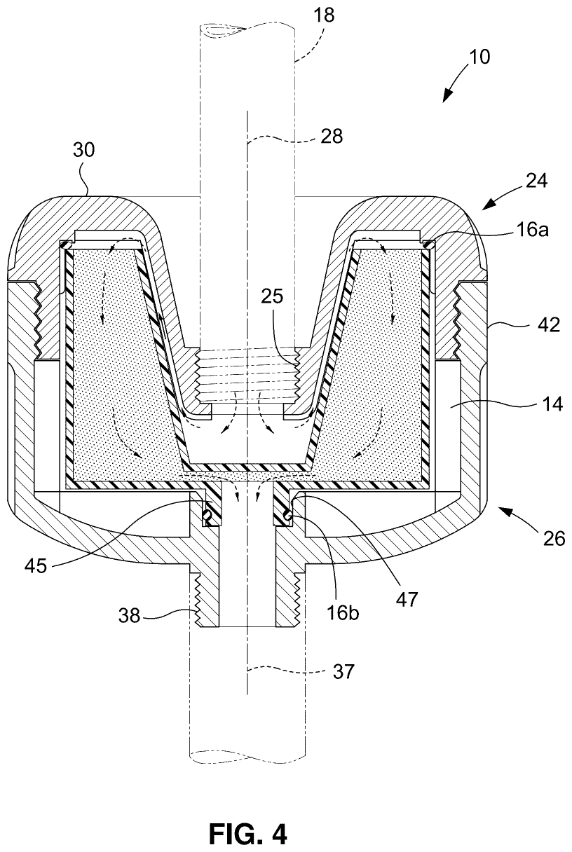

The sprayer 12 (e.g., sprayer) may have a sprayer engagement portion 22 to facilitate engagement with the shower filter 10. The sprayer 12 may also be configured to dispense the water in a desired spray pattern or configuration, such as a narrow spray configuration or wide spray configuration. The sprayer 12 may also be able to generate a massaging effect through the water spray, or pulsating water sprays, as may be desired. FIG. 2 shows the shower filter 10 disconnected from both the sprayer 12 and the water supply line 18. External washers 15 may be used to facilitate a water-tight connection between the filter 10 and the water supply line 18, and the sprayer 12.

The shower filter 10 may be configured to be installed between the distal end of the water supply line 18 and the sprayer 12. Thus, water may flow from the water supply line 18, through the shower filter 10 and then out through the sprayer 12. In other words, all water passing through the spray head would first pass through the shower filter 10.

According to one embodiment, the shower filter 10 may include a first housing body 24 and a second housing body 26, with the first and second housing bodies 24, 26, being configured to be detachable engageable with each other. The first housing body 24 may include a filter inlet 25 configured to be engageable with the water supply line 18. In one embodiment, the filter inlet 25 includes a cylindrical structure having an internally threaded surface, which may be engaged with the externally threaded surface of the water supply line 18. In the exemplary embodiment, the filter inlet 25 is located within a recess formed on the first housing body 24, which allows the distal end portion of the water supply line 18 to extend in the recess, which may allow for a more preferred positioning of the sprayer 12 in the shower. In other words, the configuration of the filter 10 may not cause the sprayer 12 to extend further into the shower by an undesired amount.

The first housing body 24 may be disposed about a first housing axis 28 which may extend through the filter inlet 15. The first housing body 24 may also include a first end wall 30 and a first side wall 32, extending from the first end wall 30. The first end wall 30 may extend outwardly from the filter inlet 15 in a direction radially outward relative to the first housing axis 28. The first sidewall 32 may extend from the first end wall 30 in a direction that is generally parallel to the first housing axis 28. The first sidewall 32 may include a threaded surface to facilitate engagement with the second housing body 26, as we will be described in more detail below. The exemplary first sidewall 32 is externally threaded, although it is understood that in other embodiments, the first sidewall 32 may be internally threaded. The first housing body 24 may additionally include an abutment surface 34, configured to a contact the second housing body 26 when the first housing body 24 is engaged with the second housing body 26. In the exemplary embodiment, the abutment surface 34 is a shoulder that extends outward from the threaded portion of the first housing body 24.

According to one embodiment, the first housing body 24 may include an internal projection 36 which may be used to stabilize the filter cartridge 14 within the filtration housing assembly, as will be described in more detail below. The projection 36 may include a distal portion and a generally frustoconical side portion having a diameter that increases as the side portion extends away from the distal portion. The distal portion of the projection 36 may be open to allow water from the water supply line 18 to enter the filter 10.

The second housing body 26 may be disposed about a second housing axis 37 and may include a filtration outlet 38 sized and configured to be engageable with the sprayer 12, with the second housing axis 37 extending through the filtration outlet 28. The filtration outlet 38 may include an externally, threaded cylindrical structure, similar in configuration to the distal end portion of the water supply line 18. The second housing body 26 may additionally include a second end wall 40 and a second cylindrical side wall 42. The second end wall 40 may extend radially outward from the filtration outlet 38 away from the second housing axis 37. The second cylindrical sidewall 42 may extend from the second end wall 40 in a direction generally parallel to the second housing axis 37. The second cylindrical sidewall 42 may include a terminal edge that defines an abutment portion 44 configured to contact the first housing body 24 during engagement with the first housing body 24. In particular, when the first housing body 24 is fully engaged with the second housing body 26, the abutment portion 34 (e.g., shoulder) of the first housing body 24 may contact the abutment portion 44 (e.g., edge) of the second housing body 26. When the first and second housing bodies 24, 26 are connected to each other, the first and second housing bodies 24, 26 may collectively define an internal void sized to receive the filter cartridge 14, as described in more detail below. The internal void may be disposed about a central axis defined by the housing assembly, i.e., the assembled first and second housing bodies 24, 26. In one embodiment, the central axis may be co-axially aligned with both the first housing axis 28 and second housing axis 37 when the first and second housing bodies 24, 26 are connected to each other.

The first and second housing bodies 24, 26 may be formed of a material capable of withstanding repeated and long-standing exposure to water. In this regard, the first and second housing bodies 24, 26 may be formed of a plastic material, a metal material, or other materials known in the art.

The shower filter 10 further includes the filter cartridge 14 which is disposed within the internal void collectively defined by the first and second housing bodies 24, 26. The filter cartridge 14 may be a generally cylindrical shaped structure having a pair of opposed generally planer surfaces 46 connected via a cylindrical side surface 48. A filtration material may be located within the filter cartridge, such as carbon or other filtration materials known in the art. The filter cartridge 14 is configured to allow water to pass therethrough while removing impurities from the water. Thus, water that is passed through the filter cartridge 14 has fewer impurities than water upstream of the filter cartridge 14. One or more ends of the filter cartridge 14 may include a boss 45 adapted to be received within a corresponding recess formed in one of the first and second housing bodies 24, 26. In the exemplary embodiment, the boss 45 is located at an outlet end of the filter cartridge 14 and is configured to be received in a corresponding outlet recess 47 on the second housing body 26. The boss 45 may include a circumferential groove 49 adapted to receive a seal, as will be explained in more detail below.

The shower filter 10 may additionally include one or more seals 16, configured to create a watertight engagement between the filter cartridge 14 and the first and second housing bodies 24, 26. In the exemplary embodiment, the shower filter 10 includes a first seal 16a configured to be disposed between the filter cartridge 14 in the first housing body 24, and a second seal 16b configured to be disposed between the filter cartridge 14 and the second housing body 26. The seals 16 may include rubber O-rings having a prescribed size and diameter. In the exemplary embodiment, the seal 16a is larger than the seal 16b. The reduced diameter of seal 16b decreases the binding force between the seal 16b and the second housing body 26, and effectively increases the leverage applied to the seal 16b when the user twists open the filter housing, as will be described in more detail below. The seals 16 are specifically configured and adapted to be spaced from the first and second side walls 32, 42 of the first and second housing bodies 24, 26. Thus, the seals 16 do not contact the abutment portion 34, 44 of the first and second housing bodies 24, 26, nor do they contact any portion of the first and second side walls 32, 42. In this regard, the seals 16 may be spaced, radially inward relative to the first and second side walls 32, 42 (e.g., between the first and second side walls 32, 42, and the corresponding first and second housing axes 28, 37). The inward positioning of the seals 16 may create a flow path through the filter housing that is spaced from a portion of the inner surface of the filter housing. In particular, an inner surface of the second side wall 42 and/or an inner surface of the first side wall 32 may be isolated from the flow path.

Seal 16a may be an O-ring having a 2.75″ diameter and 0.1″ cross section may be used to create a water-tight seal between the filter cartridge 14 and the first housing body 24. The total binding surface area of the O-ring may be 0.87 square inches. The seal 16b may be an O-ring 16 having a 0.7″ diameter and a 0.1″ cross section may be used. The total binding surface area of the smaller O-ring 16 b may be 0.22 square inches. The reduced total binding surface area of the smaller O-ring 16b may be one-quarter the total binding surface area of the larger O-ring 16a, which may be associated with 75% less resistance. Furthermore, the reduced O-ring size may be associated with an increase in leverage. As used herein, leverage may refer to the distance from the outer wall of the filter housing assembly to the O-ring 16 in a radial direction, i.e., in a direction perpendicular to the central axis (or the first or second axes 28, 37). Using the example above (e.g., comparing a 2.75″ O-ring with that of a 0.7″ O-ring), by reducing the diameter of the O-ring 16b, the leverage distance may be increased by 1.5″ (the distance from the small O-ring diameter to the outer wall). The increased leverage length may result in a tripling (e.g., 3×) of leverage magnitude, resulting in 3× the torque using same force than exerted on a larger O-ring. Therefore, the smaller O-ring 16b may require 33% less force to leverage the first and second housing bodies 24, 26 apart. In total, taking into account the 75% reduction in friction and the 33% reduction in required leverage force, using the small O-ring 16b may result in a 90% reduction in overall force required to open the filter housing.

According to one embodiment, the filter cartridge 14 and or the first and second housing bodies 24, 26 may be specifically configured and adapted to facilitate proper engagement with the seals 16. In this regard, the filter cartridge 14 and or the first and second housing bodies 24, 26 may include grooves or recesses complementary in size to that of the seals 16 to allow the seals 16 to properly nest between the filter cartridge 14 and the first and second housing bodies 24, 26. In the exemplary embodiment, the filter cartridge 14 includes a lip 50 configured to extend around the seal 16a to aid in retaining the seal 16 in its desired position relative to the filter cartridge 14. The seal 16b may reside within the circumferential groove 49 formed on the boss 45. In this regard, in the assembled filter 10, the seal 16 be may engage the boss on the inside of the seal 16b and the sidewall of the recess 47 to create a water tight seal between the filter cartridge 14 and the second housing body 26.

With the basic structure of the shower filter 10 having been described above, the following discussion relates to an exemplary use of the shower filter 10. In a new shower installation, the water supply line 18 may be detached from the sprayer 12 to allow the shower filter 10 to be installed. However, if the sprayer 12 is already attached to the water supply line 18, the sprayer 12 may be detached from the water supply line 18 by unscrewing or otherwise removing the sprayer 12 from the water supply line 18.

With the distal end portion of the water supply line 18 exposed, the assembled shower filter 10 may be attached to the water supply line 18. This may entail, attaching the filter inlet on the first housing body 24 to the distal end portion of the water supply line 18 via screwing or other engagement modalities known in the art. The sprayer head 12 may be attached to the filter 10, either prior to the filter 10 being attached to the water supply line 18, or after the filter 10 has been attached to the water supply line 18.

To assemble the filter 10, the first and second housing bodies 24, 26 may be detached from each other by unscrewing the second housing body 26 from the first housing body 24. The filter cartridge 14 may be prepared for installation in the second housing body 26 by placing seal 16b on groove 49 formed on boss 47. The filter cartridge 14, with the installed seal 16b, may be inserted into the filter cartridge 14. The seal 16a may be placed on top of the filter cartridge 14 to in preparation of attachment of the second housing body 26 to the first housing boy 24.

The second housing body 26 is then attached to the first housing body 24 by aligning the second side wall 42 with the first side wall 32. In other words, the second housing axis 37 may be aligned with the first housing axis 28. With this alignment, the second housing body 26 may be rotated to effectuate threaded engagement between the first housing body 24 and the second housing body 26. The second housing body 26 is continually rotated until the abutment portion 44 of the second housing body 26 contacts or is otherwise positioned in sufficient proximity to the apartment portion 34 of the first housing body 24. Sufficient proximity may entail, sufficient threaded engagement between the first and second side walls 32, 42, and sufficient sealing between the filter cartridge 14, the seals 16 and the first and second housing bodies 24, 26. Along these lines, as the second housing body 26 is rotated relative to the first housing body 24, the second end 40 wall is moved closer to the first end wall 30, which reduces the overall size of the internal void defined by the first and second housing bodies 24, 26. The rotational movement of the second housing body 26 relative to the first housing body 24 causes axial movement of the second end wall 40 relative to the first end wall 30. Eventually, the first housing body 24 applies a compressive force on the seal 16a to compress the seal 16a against the filter cartridge 14. The compressive forces applied on the seals 16 is done by portions of the first and second housing bodies 24, 26 that are spaced from the interface between the first and second housing bodies 24, 26. In this regard, the friction and compressive forces between the first and second housing bodies 24, 26 on the corresponding seals 16 does not make it more difficult to disassemble the second housing body 26 from the first housing body 24 during subsequent maintenance procedure procedures.

Indeed, during subsequent maintenance procedures, the filter cartridge 14 may be accessed by rotating the second housing body 26 in an opposite direction relative to the first housing body 24, which moves the second end wall 40 away from the first end wall 30. This motion of the second housing body 26 relative to the first housing body 24 increases the volume of the internal void and reduces the compressive forces applied to the seals 16. Ultimately, the first and second housing bodies 24, 26 are detached from each other to allow the filter cartridge 14 to be removed and replaced with another filter cartridge 14. The same seals 16 may be reused with the new filter cartridge 14, or the seals 16 may be replaced with new seals 16 when the new filter cartridge 14 is installed in the same manner as described above.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A shower filter for use with a shower sprayer and a water line, the shower filter comprising:
a first housing body having:
a first threaded engagement portion;
a first abutment portion; and
a water line inlet fluidly connectable to the water line to receive water therefrom;
a second housing body having:
a second threaded engagement portion;
a second abutment portion; and
a sprayer outer fluidly connectable to the shower sprayer to dispense water thereto;
the second threaded engagement portion being configured to be engageable with the first threaded engagement portion to facilitate abutment of the first abutment portion to the second abutment portion such that first housing body is connected to the second housing body to collectively define an internal housing void;
a filter cartridge being positionable within the internal housing void; and
a pair of seals, each seal being engageable with a respective portions of the filter cartridge when the first and second housing bodies are connected to each other, the pair of seals being spaced from the first and second threaded engagement portions.

2. The shower filter as recited in claim 1, wherein first housing body is configured to engage with a first one of the pair of seals at a location spaced from the first threaded engagement portion and the second housing body is configured to engage with a second one of the pair of seals at a location spaced from the second threaded engagement portion.

3. The shower filter as recited in claim 1, wherein each of the pair of seals is of a diameter that is less than that of the first and second threaded engagement portions.

4. The shower filter as recited in claim 1, wherein the internal housing void defines a central axis, each of the pair of seals is located inward of the first and second threaded engagement portions and toward central axis.

5. The shower filter as recited in claim 1, wherein the first housing body, the second housing body, the filter and the pair of seals are collectively configured such that the pair of seals are compressed between the filter and respective ones of the first and second housing bodies in response to engagement between the first and second housing bodies.

6. The shower filter as recited in claim 1, wherein the pair of seals are configured to fluidly isolate at least a portion of an inner surface of the first housing body and the second housing body from a water flow path through the shower filter.

7. The shower filter as recited in claim 1, wherein the filter cartridge includes a first lip configured to extend around a first one of the pair of seals, and a boss spaced from the first lip and having a circumferential groove adapted to receive a second one of the pair of seals.

8. A shower filter for use with a shower sprayer and a water line, the shower filter comprising:
a first housing body having:
a first engagement portion;
a first sealing portion spaced from the first engagement portion; and
a water line inlet fluidly connectable to the water line to receive water therefrom;
a second housing body having:
a second engagement portion;
a second sealing portion spaced from the first engagement portion; and
a sprayer outer fluidly connectable to the shower sprayer to dispense water thereto;
the second engagement portion being configured to be engageable with the first engagement portion to facilitate engagement between the first housing body and the second housing body to collectively define an internal housing void;
a filter cartridge being positionable within the internal housing void; and
a pair of seals, each seal being engageable with a respective portions of the filter cartridge when the first and second housing bodies are connected to each other.

9. The shower filter as recited in claim 8, wherein the pair of seals are configured to be spaced from the first and second engagement portions.

10. The shower filter as recited in claim 8, wherein each of the pair of seals is of a diameter that is less than that of the first and second engagement portions.

11. The shower filter as recited in claim 8, wherein the internal housing void defines a central axis, each of the pair of seals being located inward of the first and second engagement portions toward central axis.

12. The shower filter as recited in claim 8, wherein the first housing body, the second housing body, the filter and the pair of seals are collectively configured such that the pair of seals are compressed between the filter and respective ones of the first and second housing bodies in response to engagement between the first and second housing bodies.

13. The shower filter as recited in claim 8, wherein the pair of seals are configured to fluidly isolate at least a portion of an inner surface of the first housing body and the second housing body from a water flow path through the shower filter.

14. The shower filter as recited in claim 8, wherein the filter cartridge includes a first lip configured to extend around a first one of the pair of seals, and a boss spaced from the first lip and having a circumferential groove adapted to receive a second one of the pair of seals.

15. A shower filter for use with a shower sprayer and a water line, the shower filter comprising:
a filter housing configured to be connectable to the water line and the shower sprayer, the filter housing defining an internal void and having a first housing body and a second housing body detachably engageable to the first housing body at respective peripheral portions of the first and second housing bodies;
a filter cartridge disposable within the internal void of the filter housing and configured to remove impurities from water flowing through the filter cartridge; and
a pair of seals engageable with respective portions of the filter cartridge and the filter housing such that the filter housing, the filter cartridge, and the seals create a fluid pathway through the internal void that is spaced inwardly from the respective peripheral portions of the first and second housing bodies.

16. The shower filter recited in claim 15, wherein the first housing body is threadingly engageable to the second housing body.

17. The shower filter recited in claim 15, wherein the filter housing is configured to impart a compressive force against at least one of the pair of seals as the first housing body is engaged with the second housing body.

18. The shower filter recited in claim 17, wherein the portion of the filter housing that applies the compressive force to the pair of seals is inward of the portion of the first and second housing bodies that engage with each other.

19. The shower filter recited in claim 15, wherein the first housing body includes a first sidewall defining an inner diameter, each of the pair of seals defines a diameter that is less than the inner diameter of the sidewall.

20. The shower filter as recited in claim 15, wherein the filter cartridge includes a lip configured to extend around a first one of the pair of seals, and a groove spaced from the first lip and configured to receive a second one of the pair of seals.
